(19) United States
(12) Patent Application Publication
(10) Pub. No.: US 2026/0364834 A1
(43) Pub. Date: Nov. 19, 2026

(54) REDUCING VIBRATION-INDUCED SOUND IN A HAIR-CUTTING UNIT FOR A ROTARY ELECTRIC SHAVER

(71) Applicant: KONINKLIJKE PHILIPS N.V., EINDHOVEN (NL)

(72) Inventors: INGMAR GRASMEIJER, LEEUWARDEN (NL); REDMER VAN TIJUM, TOLBERT (NL); MARGARITA ZWANETTE VAN RAALTE, ZUIDVEEN (NL)

(21) Appl. No.: 19/133,774

(22) PCT Filed: Nov. 23, 2023
(86) PCT No.: PCT/EP2023/082775

§ 371 Date: May 29, 2025

(30) Foreign Application Priority Data
Nov. 30, 2022 (EP) 22210439.0

(51) Int. Cl. B26B 19/38; B26B 19/14

(52) U.S. Cl. CPC B26B 19/3866; B26B 19/14

(57) ABSTRACT

In the field of rotary electric shavers, a hair-cutting unit is provided, which comprises a generally cup-shaped external cutting member (10) having a circumferential annular flange (11); a rotatably arranged internal cutting member which is covered by the external cutting member (10); and a supporting member (30) configured to support the external cutting member (10) in an assembled condition of the hair-cutting unit. In said assembled condition of the hair-cutting unit and in a direction in which a central axis of the hair-cutting unit extends, the supporting member (30) only locally supports the flange (11) of the external cutting member (10) by contacting the flange (11) of the external cutting member (10) exclusively at the position of areas of the flange (11) which are vibrational node areas in the flange (11). In this way, reduction of vibration-induced sound in the hair-cutting unit is obtained.

### FIELD OF THE INVENTION

The invention relates to a hair-cutting unit for a rotary electric shaver, comprising:
a generally cup-shaped external cutting member having an annular hair-cutting area provided with hair-entry openings and having a circumferential annular flange;
an internal cutting member which is covered by the external cutting member and rotatable relative to the external cutting member about a central axis of the hair-cutting unit; and
a supporting member configured to support the external cutting member in an assembled condition of the hair-cutting unit.

Further, the invention relates to a shaving unit comprising at least one hair-cutting unit as mentioned here before, and also to a rotary electric shaver comprising a shaving unit as mentioned here before.

### BACKGROUND OF THE INVENTION

Rotary electric shavers, and also shaving units and hair-cutting units for rotary electric shavers are well known. Rotary electric shavers are generally used to shave body hair, which may be facial hair, and are powered by electric supply mains and/or by electric energy storage devices such as batteries.

In a generally known set-up, a rotary electric shaver comprises a main body configured to be gripped by a user's hand, wherein the main body and a shaving unit comprising at least one hair-cutting unit are coupled to each other in an assembled condition of the shaver. Traditionally, the hair-cutting unit comprises a combination of an external cutting member having an annular hair-cutting area provided with hair-entry openings as a non-driven component and an internal cutting member as a driven component, wherein at least the internal cutting member has one or more cutting edges. In such a case, use of the hair-cutting unit as incorporated in the shaving unit of the rotary electric shaver involves putting the hair-cutting unit to an operation mode in which the internal cutting member of the hair-cutting unit is actually rotated, and moving the shaving unit over the skin in such a way that the hair-cutting area of the external cutting member of the hair-cutting unit faces and contacts the skin. In this process, hairs protruding from the skin are caught in an interior space of the hair-cutting unit in which they are made to abut against the external cutting member at the position of a hair-entry opening and are cut through when they are encountered by a cutting edge of the rotating internal cutting member.

EP 3 643 460 A1 discloses a hair-cutting unit of a shaving head of a rotary electric shaver. The hair-cutting unit has a retainer comprising a first retaining mechanism, a second retaining mechanism, and a third retaining mechanism. In a shaving-ready assembled condition of the hair-cutting unit, said three retaining mechanisms are retaining, respectively, an internal cutting member and an external cutting member of the hair-cutting unit and a skin-supporting member of the shaving head. In a cutting-ready assembled condition of the hair-cutting unit, the third retaining mechanism has been released as compared to said shaving-ready assembled condition. In a cutting-prepared assembled condition, the second retaining mechanism has been released as compared to said cutting-ready assembled condition. The first retaining mechanism comprises an elastic snap connection mechanism to retain the retainer and the internal cutting member together. The second retaining mechanism comprises snap connection portions of the retainer for snap connection to a flange of the external cutting member. The third retaining mechanism comprises snap connection portions of the retainer for snap connection to a flange of the skin-supporting member.

To reduce manufacturing costs and the ecological footprint, it is common practice to make the external cutting member from thin sheet material. A practical example in this respect is a sheet thickness of 0.1 mm. However, a smaller thickness of the sheet material involves a higher level of sound coming from the external cutting member in the operation mode of the hair-cutting unit, when the hair-cutting unit is not on the skin. This sound is caused by excitation of the resonance frequencies of the external cutting member by the rotating internal cutting member. The vibration is transferred to the supporting member of the hair-cutting unit on which the external cutting member is supported via an annular flange of the external cutting member. Due to the vibration causing excitation of the resonance frequencies of the supporting member, the overall sound produced by the hair-cutting unit and the shaving unit comprising the hair-cutting unit is increased.

In view of the foregoing, it is an object of the invention to design a hair-cutting unit in such a way that the overall level of sound produced by the hair-cutting unit and the shaving unit comprising the hair-cutting unit in the operation mode is reduced without needing to increase thickness of the external cutting member.

### SUMMARY OF THE INVENTION

The invention provides a hair-cutting unit for a rotary electric shaver, comprising:
a generally cup-shaped external cutting member having an annular hair-cutting area provided with hair-entry openings and having a circumferential annular flange;
an internal cutting member which is covered by the external cutting member and rotatable relative to the external cutting member about a central axis of the hair-cutting unit; and
a supporting member configured to support the external cutting member in an assembled condition of the hair-cutting unit.

To achieve the object of the invention, the hair-cutting unit according to the invention is characterized in that:
the supporting member is configured to only locally support the flange of the external cutting member in the assembled condition of the hair-cutting unit and in a direction in which the central axis extends by contacting the flange of the external cutting member exclusively at the position of areas of the flange which are vibrational node areas in the flange where a value of an amplitude of a vibration of the external cutting member at a resonance frequency as occurs during operation of the hair-cutting unit as a result of rotation of the internal cutting member is minimal; and
in the assembled condition of the hair-cutting unit and at positions different from the position of said areas of the flange which are vibrational node areas, the flange of the external cutting member is at a distance of at least 0.2 mm from the supporting member, as seen in the direction in which the central axis extends.

It follows from the above that in the hair-cutting unit according to the invention, special measures are taken at the interface between the flange of the external cutting member and the supporting member. The design of the hair-cutting unit is such that in the assembled condition of the hair-cutting unit and in the direction in which the central axis extends, the flange of the external cutting member is supported by the supporting member only locally, namely exclusively at the position of vibrational node areas in the flange. The measures of the invention do not only involve minimalization of the contact between the external cutting member and the supporting member, but also clever positioning of the minimalized contact. Contacting the flange of the external cutting member exclusively at the position of vibrational node areas in the flange results in minimizing the extent to which vibration can be transferred from the external cutting member to the supporting member and thereby in minimizing the overall level of sound produced by the hair-cutting unit and the shaving unit comprising the hair-cutting unit during operation. Advantageously, in order to achieve significant sound-reducing effects, indeed, the vibrational node areas are vibrational node areas of a first resonance frequency of the external cutting member.

In view of the foregoing, it is practical if the supporting member comprises at least three bearing elements which are interspaced in a direction about the central axis and which project from an annular internal surface of the supporting member. Advantageously, areas of contact between the flange of the external cutting member and the internal surface of the supporting member are as small as possible. In this respect, it is practical if the bearing elements of the supporting member are generally ridge-shaped. Taking into account common dimensioning of the hair-cutting unit, in order to guarantee that the flange of the external cutting member does not contact the internal surface of the supporting member in areas outside of the bearing elements, in particular when the flange is vibrating, it is practical if in the assembled condition of the hair-cutting unit and at positions different from the positions of the bearing elements of the supporting member, the flange of the external cutting member is at a distance of at least 0.2 mm from the internal surface of the supporting member, as seen in the direction in which the central axis extends.

The invention covers any appropriate number of bearing elements of the supporting member, such as three and four. Generally speaking, it is appropriate to choose the number of bearing elements of the supporting member in relation to the number of vibrational node areas in the flange of the external cutting member, wherein the number of bearing elements may be the same as the number of vibrational node areas or may be less than the number of vibrational node areas. In this respect, it is noted that for any given hair-cutting unit and external cutting member, simulations and/or tests are useful to determine the number and positions of the vibrational node areas of the flange of the external cutting member. The bearing elements may then be arranged in positions on the supporting member corresponding with the positions of the vibrational node areas on the flange of the external cutting member.

In the context of the invention, the bearing elements of the supporting member may be provided in any suitable way. Practical options in this respect include the bearing elements comprising locally elevated areas of the internal surface of the supporting member and the bearing elements being provided as add-ons on the internal surface of the supporting member.

In a practical embodiment of the hair-cutting unit according to the invention, the flange of the external cutting member comprises a pair of arresting recesses arranged in diametrically opposite positions relative to the central axis, and the supporting member comprises a pair of arresting notches arranged to engage the pair of arresting recesses in the flange of the external cutting member in the assembled condition of the hair-cutting unit to prevent rotation of the external cutting member about the central axis. The arresting notches are suitable to be used as a reference orientation which, combined with simulated or measured positions of the vibrational node areas, determines the positions of the bearing elements. For example, it is possible that four vibrational node areas are found at such positions relative to the arresting notches that it is appropriate that the number of bearing elements of the supporting member is four, and that those four bearing elements are arranged in a pattern in which, as seen in a direction about the central axis, the bearing elements are at mutual angular distances of 90° and angular distances of 45° are present between bearing elements and arresting notches.

In a practical embodiment of the hair-cutting unit according to the invention, the supporting member is of the type having an opening through which a part of the external cutting member other than the flange extends in the assembled condition of the hair-cutting unit. Such a supporting member may further have an annular external surface at a skin-facing side of the hair-cutting unit.

The invention further relates to a shaving unit, comprising a base member and at least one hair-cutting unit as defined and described here before supported by the base member, and also to a rotary electric shaver comprising such a shaving unit. In a practical embodiment, the rotary electric shaver according to the invention comprises a main body configured to be gripped by a user's hand, wherein the shaving unit and the main body are coupled to each other in an assembled condition of the shaver.

The above-described and other aspects of the invention will be apparent from and elucidated with reference to the following detailed description of an embodiment of a hair-cutting unit in which the supporting member comprises four bearing elements arranged and configured to realize contact between the supporting member and the flange of the external cutting member only to a minimal extent and at a position of vibrational node areas in the flange.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows a perspective view of a rotary electric shaver according to an embodiment of the invention, which shaver comprises a main body and a shaving unit with three hair-cutting units;

FIG. 2 diagrammatically shows an exploded perspective view of an external cutting member and an internal cutting member of a hair-cutting unit;

FIG. 3 diagrammatically shows an exploded perspective view of a number of components of the hair-cutting unit, including the external cutting member and a supporting member, and excluding the internal cutting member;

FIG. 4 diagrammatically shows a perspective view of the supporting member;

FIG. 5 diagrammatically shows a longitudinal sectional view of the supporting member;

FIG. 6 diagrammatically shows a top view of the external cutting member; and

FIG. 7 diagrammatically shows a detail of the supporting member and the external cutting member in a position of being supported on the supporting member.

### DETAILED DESCRIPTION OF THE EMBODIMENTS

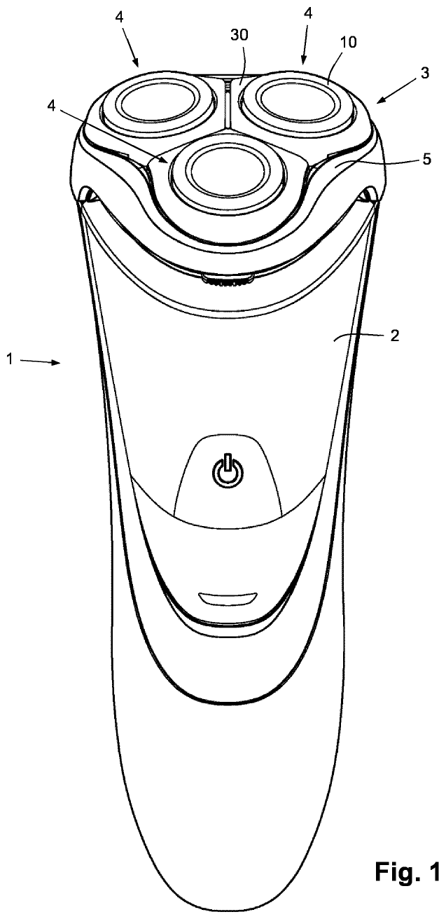

FIG. 1 shows an electric shaver 1 of the rotary type, which is suitable to be used for shaving a beard, as a practical example of a rotary electric shaver according to the invention. The shaver 1 comprises a main body 2 and a shaving unit 3 in which three hair-cutting units 4 are arranged, wherein the hair-cutting units 4 are supported by a base member 5 of the shaving unit 3. The main body 2 is designed to enable a user of the shaver 1 to take hold of the shaver 1 and to handle the shaver 1, wherein the shaving unit 3 constitutes the part of the shaver 1 which is to be positioned on and moved over the skin for hair removal.

When the shaver 1 is actually applied for the purpose of performing a shaving action, the actual process of cutting of hairs protruding from the skin takes place at the position of the hair-cutting units 4. In the context of the invention, the number of hair-cutting units 4 arranged in the shaving unit 3 can be chosen freely and does not necessarily need to be three. The main body 2 may have a function in accommodating at least one electric motor for driving components of the respective hair-cutting units 4. The main body 2 may further include means such as a rechargeable battery for powering the at least one electric motor. It is practical if the shaving unit 3 and the main body 2 are releasably connectable to each other, as known per se in the field of rotary electric shavers.

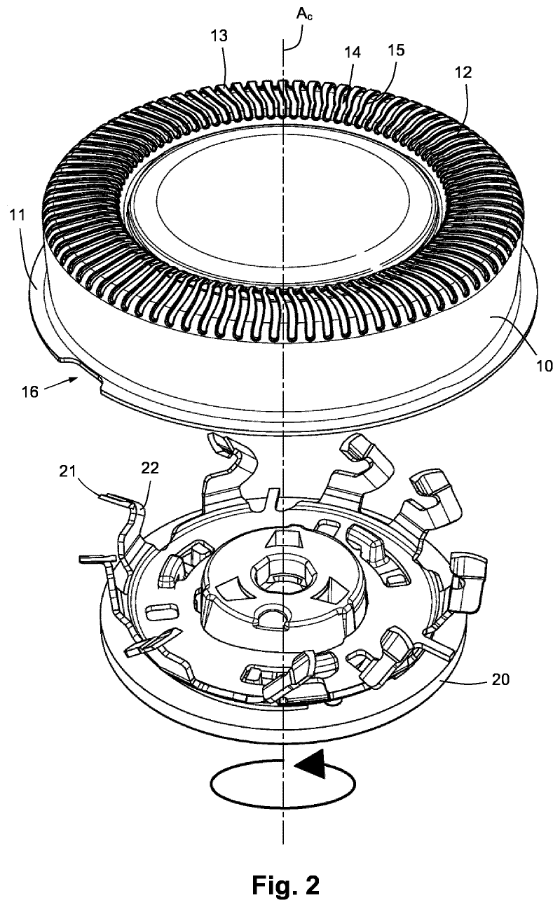

Each of the hair-cutting units 4 comprises a combination of an external cutting member 10 and an internal cutting member 20. Details of the combination of the external cutting member 10 and the internal cutting member 20 are now described with reference to FIG. 2. The external cutting member 10 is of a generally cup-shaped design and is thereby suitable for at least partially accommodating the internal cutting member 20 in its interior. The external cutting member 10 has a circumferential annular flange 11 as an outwardly bent rim of the general cup shape. The external cutting member 10 has an annular hair-cutting area, also referred to as shaving track 12, wherein an upper surface of the shaving track 12 serves to face and contact the skin to be subjected to a shaving action. The shaving track 12 comprises lamellae 13 extending along the width of the shaving track 12, in a substantially radial direction relative to a central axis A_{c} of the hair-cutting unit 4, which coincides with a rotational axis about which the internal cutting member 20 is rotatable relative to the external cutting member 10. Apertures as present between the lamellae 13 constitute hair-entry openings 14 of the shaving track 12. Sides of the lamellae 13 constitute hair-cutting surfaces 15 suitable for cutting off hairs in cooperation with hair-cutting edges 21 of hair-cutting elements 22 of the internal cutting member 20. The invention also relates to cases in which the shaving track 12 does not comprise lamellae 13 or does not only comprise lamellae 13, such as cases in which the entire shaving track 12 is provided with teeth-like elements and/or a pattern of (circular) holes instead of or in addition to lamellae 13. Also, the invention relates to cases in which more than one shaving tracks 12 are present in the external cutting member 10. It is noted that for the sake of clarity, the lamellae 13 and the hair-entry openings 14 of the shaving track 12 are not depicted in FIG. 1.

A shaving action can be performed when the internal cutting member 20 is activated to rotate and a portion of skin is actually contacted by the external cutting member 10 at the position of the shaving track 12. A direction of rotation about the central axis A_{c} is indicated in FIG. 2 by means of an arrow. Activation of the internal cutting member 20 may take place in a known manner by means of a drive mechanism of the rotary electric shaver 1. When the combination of the external cutting member 10 and the internal cutting member 20 is moved over the portion of skin while the internal cutting member 20 is driven to rotate, it is achieved that hairs protruding from the portion of skin are caught in the hair-entry openings 14 of the shaving track 12 of the external cutting member 10 and are cut off in that position as result of a cooperation between the hair-cutting surfaces 15 of the shaving track 12 of the external cutting member 10 and the hair-cutting edges 21 of the hair-cutting elements 22 of the rotating internal cutting member 20.

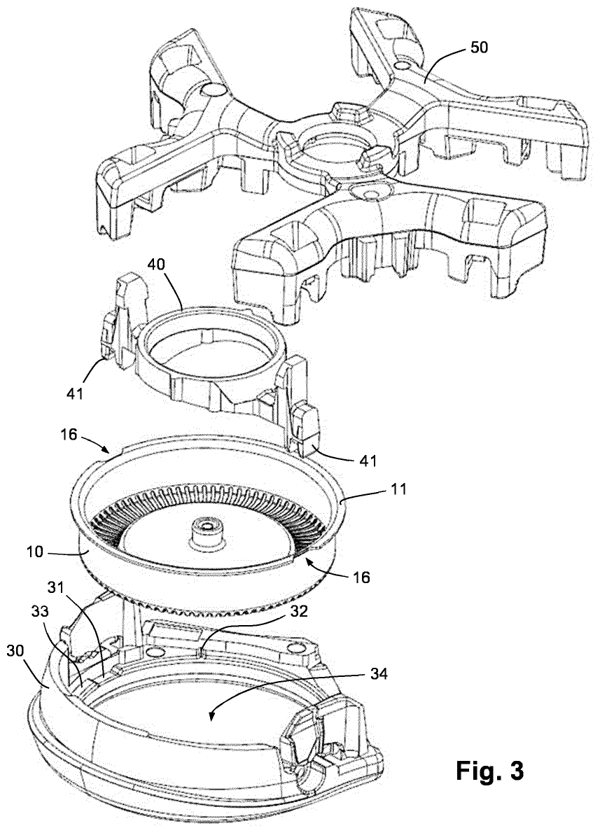

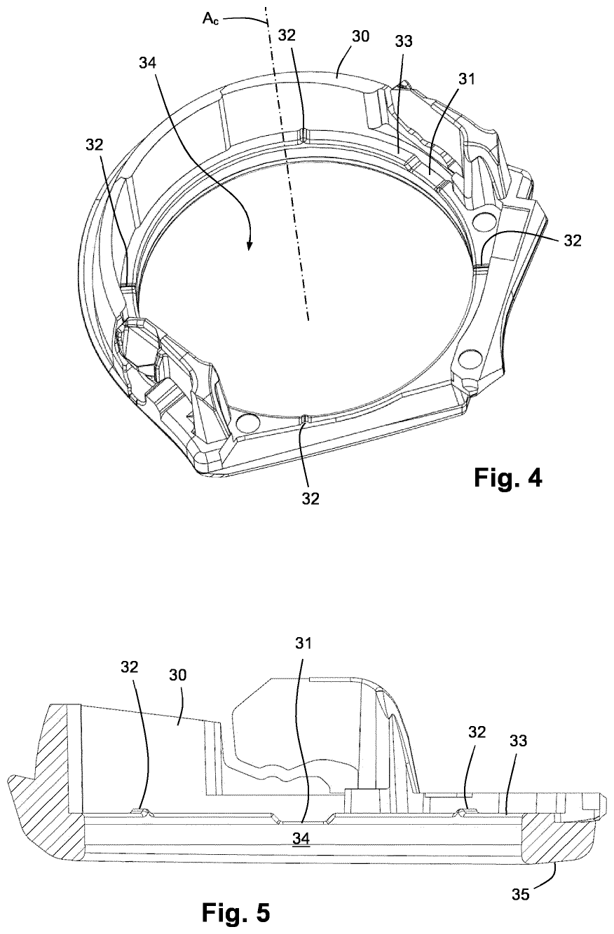

With reference to FIG. 3, it is noted that the external cutting member 10 is held in the hair-cutting unit 4 between a supporting member 30 on the one side and a combination of retaining members 40, 50 on the other side. The supporting member is separately shown in FIGS. 4 and 5. A first one 40 of the retaining members 40, 50 has a function in fixing the position of the external cutting member 10 about the central axis A_{c}. The fact is that the flange 11 of the external cutting member 10 comprises a pair of arresting recesses 16 arranged in diametrically opposite positions relative to the central axis A_{c}, and that the supporting member 30 comprises a pair of arresting notches 31 arranged to engage the pair of arresting recesses 16 in the flange 11 of the external cutting member 10 in the assembled condition of the hair-cutting unit 4. The first retaining member 40 comprises a pair of fixing elements 41. In the assembled condition of the hair-cutting unit 4, the external cutting member 10 and the supporting member 30 are positioned relative to each other in such a way that the arresting recesses 16 of the flange 11 of the external cutting member 10 are aligned with the arresting notches 31 of the supporting member 30, and the fixing elements 40 are arranged to accommodate portions of the flange 11 of the external cutting member 10 and the supporting member 30 at the position of the aligned arresting recesses 16 and arresting notches 31, thereby realizing fixation of said portions relative to each other.

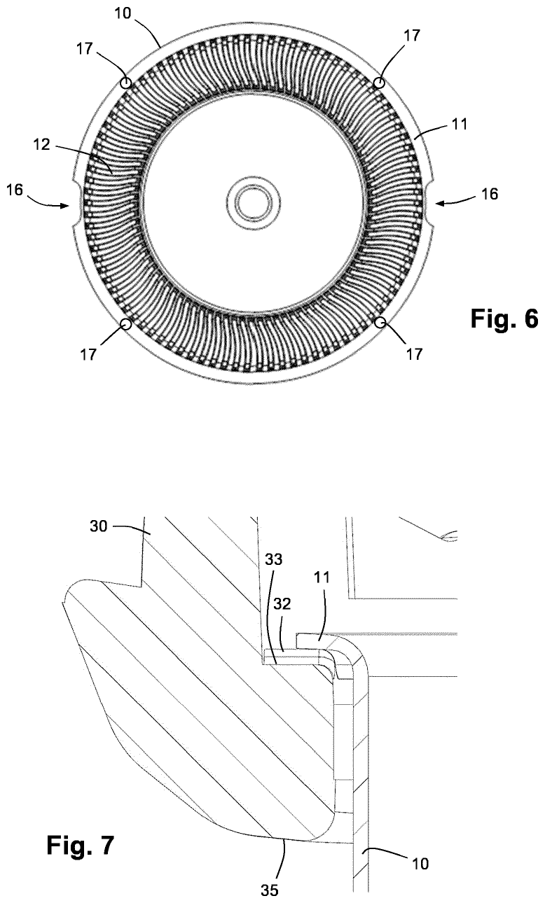

The external cutting member 10 has a relatively small wall thickness. As a consequence, vibration of the external cutting member 10 at a resonance frequency occurs when the internal cutting member 20 is rotated during operation of the hair-cutting unit 4, and the vibration of the external cutting member 10 is passed on from the external cutting member 10 to other components of the hair-cutting unit 4, including the supporting member 30. It is an insight of the invention that in view of the level of sound coming from the hair-cutting unit 4 during operation, especially when the hair-cutting unit 4 is free from contact to the skin, it is advantageous if measures are taken on the basis of which the extent to which a vibration of the external cutting member 10 is passed on to the supporting member 30 is minimized. In view thereof, in the present example, the supporting member 30 is equipped with four ridge-shaped bearing elements 32 projecting from an annular internal surface 33 of the supporting member 30, as can best be seen in FIG. 4. On the basis of the presence of the bearing elements 32 in the supporting member 30, minimization of the area of contact of the flange 11 of the external cutting member 10 and the supporting member 30 is realized. The positioning of the bearing elements 32 is adapted to the positioning of areas of the flange 11 which are vibrational node areas 17 in the flange 11 where a value of an amplitude of a vibration of the external cutting member 10 at a resonance frequency is minimal. In that way, it is achieved that sound reduction is realized on the basis of a double effect of having a minimal area of contact and having said minimal area of contact at the very position where the amplitude of the vibration of the flange 11 is minimal. The positions of the vibrational node areas 17 associated with the first resonance frequency of the external cutting member 10 are indicated by means of circles in FIG. 6.

With reference to FIG. 6, it is noted that in the present case of the flange 11 of the external cutting member 10 being provided with two arresting recesses 16 arranged in diametrically opposite positions relative to the central axis A_{c}, the vibrational node areas 17 in the flange 11 are at positions of angular distances of 45° to the arresting recesses 16 and thereby equally distributed among the circumference of the flange 11 with mutual angular distances of 90°. In view thereof, the four bearing elements 32 of the supporting member 30 are arranged in a pattern which is rotated 45° relative to the arresting notches 31, as seen in a direction about the central axis A_{c}. In embodiments of the external cutting member 10 in which the flange 11 has a different appearance such as due to different positioning of the arresting recessed 16, another positioning of the vibrational node areas 17 in the flange 11 may be expected. The design of the supporting member 30 can easily be adapted to another positioning of the vibrational node areas 17 in the flange 11 as this requires no more than an adjustment of the positions of the bearing elements 32 of the supporting member 30.

It is practical if in the manufacturing process of the supporting member 30, the internal surface 33 of the supporting member 30 is shaped in such a way that the bearing elements 32 are formed in the material making up the surface 33. That does not alter the fact that it is also possible that the bearing elements 32 are realized through appropriate add-ons. In any case, in comparison to a conventional hair-cutting unit, noise reduction is obtained in a relatively simple fashion, namely by adapting the design of the supporting member 30 to a design in which the supporting member 30 comprises at least three bearing elements 32 as shown and described, at positions corresponding to positions of vibrational node areas 17 in the flange 11 of the external cutting member 10, with spaces between said bearing elements 32 where contact between the supporting member and the flange 11 is prevented under all normal operational circumstances. In this respect, it is noted that a practical example of a height of the bearing elements 32, i.e. a dimension of the bearing elements 32 in a direction in which the central axis A_{c} extends, is 0.2 mm, so that it is achieved that in the assembled condition of the hair-cutting unit 4 and at positions different from the positions of the bearing elements 32, the flange 11 is at a distance of at least 0.2 mm from the internal surface 33, as seen in said direction.

Among other things, the supporting member 30 is provided with an opening 34 which is dimensioned such as to realize that during assembly of the hair-cutting unit 4, only the part of the external cutting member 10 other than the flange 11 is allowed to pass through the opening 34 while the flange 11 cannot and is made to settle on the bearing elements 32 of the supporting member 30 instead. Further, the supporting member 30 has an annular external surface 35 at a skin-facing side of the hair-cutting unit 4. FIG. 7 serves to illustrate the configuration in which the flange 11 of the external cutting member 10 is contacted by the bearing elements 32 of the supporting member 30 and in which the other part of the external cutting member 10 extends through the opening 34 in the supporting member 30.

It will be clear to a person skilled in the art that the scope of the invention is not limited to the examples discussed in the foregoing, and that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The terms “comprise” and “include” as used in the present text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

In the context of the invention, it is not essential which side of the flange 11 of the external cutting member 10 is contacted in the way as described in the foregoing, i.e. in the way which is aimed at having only minimal contact and having said minimal contact exclusively at the position of vibrational node areas 17 in the flange 11.

Notable aspects of the invention are summarized as follows. In the field of rotary electric shavers, a hair-cutting unit 4 is provided, which comprises a generally cup-shaped external cutting member 10 having a circumferential annular flange 11; a rotatably arranged internal cutting member 20 which is covered by the external cutting member 10; and a supporting member 30 configured to support the external cutting member 10 in an assembled condition of the hair-cutting unit 4. In said assembled condition of the hair-cutting unit 4 and in a direction in which a central axis A_{c} of the hair-cutting unit 4 extends, the supporting member 30 only locally supports the flange 11 of the external cutting member 10 by contacting the flange 11 of the external cutting member 10 exclusively at the position of areas of the flange 11 which are vibrational node areas 17 in the flange 11 where a value of an amplitude of a vibration of the external cutting member 10 at a resonance frequency as occurs during operation of the hair-cutting unit 4 when the internal cutting member 20 rotates is minimal. In this way, reduction of vibration-induced sound in the hair-cutting unit 4 is obtained.

1. Hair-cutting unit (4) for a rotary electric shaver (1), comprising:
a generally cup-shaped external cutting member (10) having an annular hair-cutting area (12) provided with hair-entry openings (14) and having a circumferential annular flange (11);
an internal cutting member (20) which is covered by the external cutting member (10) and rotatable relative to the external cutting member (10) about a central axis (A_{c}) of the hair-cutting unit (4); and
a supporting member (30) configured to support the external cutting member (10) in an assembled condition of the hair-cutting unit (4);
characterized in that:
the supporting member (30) is configured to only locally support the flange (11) of the external cutting member (10) in the assembled condition of the hair-cutting unit (4) and in a direction in which the central axis (A_{c}) extends by contacting the flange (11) of the external cutting member (10) exclusively at the position of areas of the flange (11) which are vibrational node areas (17) in the flange (11) where a value of an amplitude of a vibration of the external cutting member (10) at a resonance frequency as occurs during operation of the hair-cutting unit (4) as a result of rotation of the internal cutting member (20) is minimal; and
in the assembled condition of the hair-cutting unit and at positions different from the position of said areas of the flange which are vibrational node areas, the flange of the external cutting member is at a distance of at least 0.2 mm from the supporting member, as seen in the direction in which the central axis extends.

2. Hair-cutting unit (4) as claimed in claim 1, wherein the vibrational node areas (17) are vibrational node areas (17) of a first resonance frequency of the external cutting member (10).

3. Hair-cutting unit (4) as claimed in claim 1, wherein the supporting member (30) comprises at least three bearing elements (32) which are interspaced in a direction about the central axis (A_{c}) and which project from an annular internal surface (33) of the supporting member (30).

4. Hair-cutting unit (4) as claimed in claim 3, wherein in the assembled condition of the hair-cutting unit (4) and at positions different from the positions of the bearing elements (32) of the supporting member (30), the flange (11) of the external cutting member (10) is at a distance of at least 0.2 mm from the internal surface (33) of the supporting member (30), as seen in the direction in which the central axis (A_{c}) extends.

5. Hair-cutting unit (4) as claimed in claim 3, wherein the number of bearing elements (32) of the supporting member (30) is three or four.

6. Hair-cutting unit (4) as claimed in claim 3, wherein the bearing elements (32) of the supporting member (30) are generally ridge-shaped.

7. Hair-cutting unit (4) as claimed in claim 3, wherein the bearing elements (32) of the supporting member (30) comprise locally elevated areas of the internal surface (33) of the supporting member (30).

8. Hair-cutting unit (4) as claimed in claim 3, wherein the bearing elements (32) of the supporting member (30) are provided as add-ons on the internal surface (33) of the supporting member (30).

9. Hair-cutting unit (4) as claimed in claim 3, wherein:
the flange (11) of the external cutting member (10) comprises a pair of arresting recesses (16) arranged in diametrically opposite positions relative to the central axis (A_{c});
the supporting member (30) comprises a pair of arresting notches (31) arranged to engage the pair of arresting recesses (16) in the flange (11) of the external cutting member (10) in the assembled condition of the hair-cutting unit (4) to prevent rotation of the external cutting member (10) about the central axis (A_{c});
the number of bearing elements (32) of the supporting member (33) is four; and
the four bearing elements (32) of the supporting member (30) are arranged in a pattern in which, as seen in the direction about the central axis (A_{c}), the bearing elements (32) are at mutual angular distances of 90° and angular distances of 45° are present between bearing elements (32) and arresting notches (31).

10. Hair-cutting unit (4) as claimed in claim 1, wherein the supporting member (30) is provided with an opening (34) through which a part of the external cutting member (10) other than the flange (11) extends in the assembled condition of the hair-cutting unit (4).

11. Hair-cutting unit (4) as claimed in claim 10, wherein the supporting member (30) has an annular external surface (35) at a skin-facing side of the hair-cutting unit (4).

12. Shaving unit (3), comprising a base member (5) and at least one hair-cutting unit (4) as claimed in claim 1 supported by the base member (5).

13. Rotary electric shaver (1), comprising a shaving unit (3) as claimed in claim 12.

14. Rotary electric shaver (1) as claimed in claim 13, comprising a main body (2) configured to be gripped by a user's hand, wherein the shaving unit (3) and the main body (2) are coupled to each other in an assembled condition of the shaver (1).
